(19) United States
(12) Patent Application Publication
(10) Pub. No.: US 2024/0406939 A1
(43) Pub. Date: Dec. 5, 2024

(54) ELECTRONIC DEVICE FOR MANAGING HARDWARE RESOURCE, AND OPERATING METHOD THEREOF

(71) Applicant: Samsung Electronics Co., Ltd., Suwon-si (KR)

(72) Inventors: Hyuna JO, Suwon-si (KR); Hyunjee KIM, Suwon-si (KR)

(21) Appl. No.: 18/805,230

(22) Filed: Aug. 14, 2024

Related U.S. Application Data
(63) Continuation of application No. PCT/KR2023/002073, filed on Feb. 13, 2023.

(30) Foreign Application Priority Data
Feb. 14, 2022 (KR) 10-2022-0018675
Mar. 11, 2022 (KR) 10-2022-0031051

(51) Int. Cl. H04W 72/0446; H04L 41/0896; H04W 28/16

(52) U.S. Cl. CPC H04W 72/0446; H04L 41/0896; H04W 28/16

(57) ABSTRACT

According to various embodiments, a method of operating an electronic device may comprise: identifying radio resource allocation information for each of a plurality of physical channels in a first slot, based on a control plane message including radio resource allocation information for the first slot; identifying each of prediction operation amounts for each of the plurality of physical channels, based on the radio resource allocation information for each of the plurality of physical channels; identifying an available operation amount for each of a plurality of hardware resources supported by the electronic device; and allocating each of the plurality of physical channels to at least some of the plurality of hardware resources, based on the available operation amount for each of the plurality of hardware resources and the prediction operation amount for each of the plurality of physical channels.

### CROSS-REFERENCE TO RELATED APPLICATIONS

This application is a continuation of International Application No. PCT/KR2023/002073 designating the United States, filed on Feb. 13, 2023, in the Korean Intellectual Property Receiving Office and claiming priority to Korean Patent Application Nos. 10-2022-0018675, filed on Feb. 14, 2022, and 10-2022-0031051, filed on Mar. 11, 2022, in the Korean Intellectual Property Office, the disclosures of each of which are incorporated by reference herein in their entireties.

### BACKGROUND

### Field

The disclosure relates to an electronic device for managing a hardware resource for interaction with a radio unit of a network and a method for operating the same.

### Description of Related Art

A conventional base station is implemented in the form in which a data processing unit (distributed unit (DU)) and a wireless transmission/reception unit (radio unit or remote unit (RU)) of the base station are together installed in a cell site. However, such an integrated implementation has physical limitations. For example, as service subscribers or traffic increases, the operator needs to establish a new cell site in the base station. To address this issue, the centralized radio access network (C-RAN) or cloud RAN structure has been implemented. The C-RAN may have a structure in which the DU is placed in one physical place, and the RU is placed in the cell site which actually transmits/receives radio signals to/from the user equipment (UE). The DU and the RU may be connected via an optical cable or a coaxial cable. As the RU and the DU are separated, an interface standard for communication therebetween is needed, and such standards as the common public radio interface (CPRI), are used between the RU and the DU. The 3rd generation partnership project (3GPP) is standardizing base station structures and is in the middle of discussing the open radio access network (O-RAN) which is an open network standard applicable to 5G systems. In the O-RAN, the RU, DU, central unit-control plane (CU-CP), and central unit-user plane (CU-UP) which are conventional 3GPP NEs are newly defined as an O-RU, O-DU, O-CU-CP, and O-CU-UP, respectively (which may be collectively referred to as O-RAN base stations), and RAN intelligent controller (RIC) and non-real-time RAN intelligent controller (NRT-RIC) have been additionally proposed.

In a C-RAN environment, limited hardware resources may be shared by multiple containers. In this case, when hardware resources are fixedly allocated to containers without considering traffic between RU and DU, there may be a possibility that hardware resources may be used inefficiently according to traffic that changes in real-time. In particular, traffic for each physical channel may change at every slot, and in this case, the fixed hardware resource allocation scheme may be inefficient.

### SUMMARY

Embodiments of the disclosure provide an electronic device and an operation method thereof, that may allocate a plurality of physical channels to hardware resources based on a predicted computation amount based on radio resource allocation information for each of a plurality of physical channels and an available computation amount for each hardware resource.

According to various example embodiments, a method for operating an electronic device may comprise: identifying radio resource allocation information for each of a plurality of physical channels in a first slot, based on a control plane message including radio resource allocation information for the first slot, identifying each of predicted computation amounts for each of the plurality of physical channels, based on the radio resource allocation information for each of the plurality of physical channels, identifying an available computation amount for each of a plurality of hardware resources supported by the electronic device, and allocating each of the plurality of physical channels to at least some of the plurality of hardware resources, based on the available computation amount for each of the plurality of hardware resources and the predicted computation amount for each of the plurality of physical channels.

According to various example embodiments, an electronic device may comprise memory, and at least one processor, comprising processing circuitry, operatively connected to the memory. The memory may store at least one instruction, wherein at least one processor, individually and/or collectively, is configured to execute the at least one instruction and to cause the electronic device to: identify radio resource allocation information for each of a plurality of physical channels in a first slot, based on a control plane message including radio resource allocation information for the first slot, identify each of the predicted computation amounts for each of the plurality of physical channels based on the radio resource allocation information for each of the plurality of physical channels, identify an available computation amount for each of a plurality of hardware resources supported by the electronic device, and allocate each of the plurality of physical channels to at least some of the plurality of hardware resources, based on the available computation amount for each of the plurality of hardware resources and the predicted computation amount for each of the plurality of physical channels.

According to various example embodiments, a method for operating an electronic device may comprise: identifying a first radio resource allocation amount of a first physical channel and a second radio resource allocation amount of a second physical channel in a first slot based on a control plane message including radio resource allocation information for the first slot, based on a computation corresponding to the first radio resource allocation amount and the second radio resource allocation amount being performed by a first hardware resource supported by the electronic device, allocating the first physical channel and the second physical channel to the first hardware resource, and based on the computation corresponding to the first radio resource allocation amount and the second radio resource allocation amount not being performed by the first hardware resource supported by the electronic device, allocating one of the first physical channel or the second physical channel to the first hardware resource and allocating a remaining channel to the second hardware resource different from the first hardware resource.

According to various example embodiments, there may be provided an electronic device and an operation method thereof, which may allocate a plurality of physical channels to hardware resources based on a predicted computation amount based on radio resource allocation information for each of a plurality of physical channels and an available computation amount for each hardware resource.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1A is a block diagram illustrating an RIC, an RAN and a core network (CN) according to various embodiments;

FIG. 1B is a block diagram illustrating an example hardware configuration of an electronic device according to various embodiments;

FIG. 2 is a block diagram illustrating an example configuration of an entity for hardware resource allocation, according to various embodiments;

FIG. 3A is a flowchart illustrating example operations of an electronic device according to various embodiments;

FIG. 3B is a signal flow diagram illustrating example operations of transmission/reception of a control plane message and user plane data, according to various embodiments;

FIG. 4 is a diagram illustrating example allocation of a hardware resource of physical channels according to various embodiments;

FIG. 5 is a flowchart illustrating example operations of an electronic device according to various embodiments;

FIG. 6 is a diagram illustrating example allocation of a hardware resource of physical channels according to various embodiments;

FIG. 7 is a flowchart illustrating example operations of an electronic device according to various embodiments;

FIG. 8 is a flowchart illustrating example operations of an electronic device according to various embodiments;

FIG. 9 is a flowchart illustrating example operations of an electronic device according to various embodiments;

FIG. 10 is a diagram illustrating example allocation of a physical channel according to a comparative example and allocation of a physical channel according to various embodiments, for comparison with various embodiments; and

FIG. 11 is a diagram illustrating example allocation of a physical channel according to a comparative example and allocation of a physical channel according to various embodiments, for comparison with various embodiments.

### DETAILED DESCRIPTION

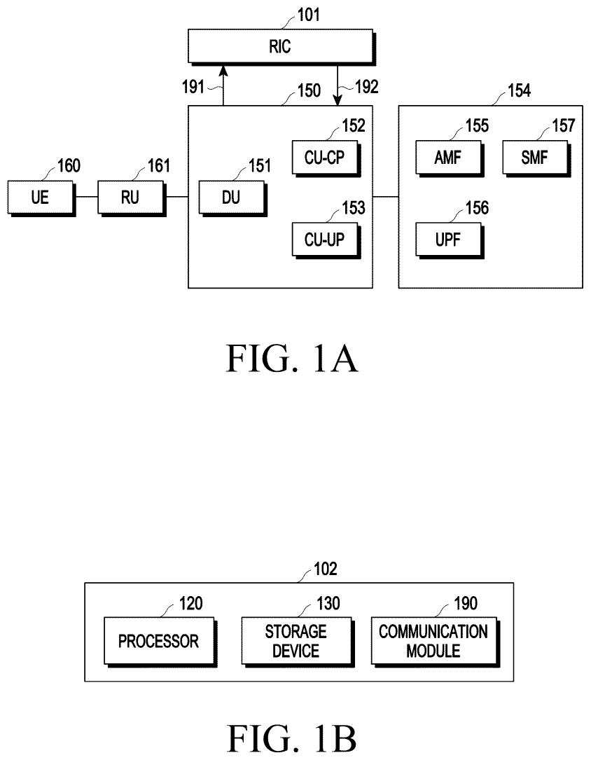

FIG. 1A is a block diagram illustrating an RIC, an RAN and a core network (CN) according to various embodiments.

According to various embodiments, a RAN 150 may include at least one distributed unit (DU) 151, at least one central unit-control plane (CU-CP) 152, or at least one central unit-user plane (CU-UP) 153. Although the RAN 150 is illustrated as being connected to at least one remote unit or radio unit (RU) 161, this is an example and at least one RU 161 may be connected to, or included in, the RAN 150. The RAN 150 may be a C-RAN or an O-RAN and, if it is an O-RAN, the DU 151 may be an O-DU, the CU-CP 152 may be an O-CU-CP, the CU-UP 153 may be an O-CU-UP, and the RU 161 may be an O-RU.

According to various embodiments, the RU 161 may perform communication with a user equipment (UE) 160. The RU 161 may be a logical node that provides a low-PHY function and RF processing. The DU 151 may be a logical node that provides the functions of RLC, MAC, and a higher physical layer (high-PHY) and be connected to, e.g., the RU 161. The CUs 152 and 153 may be logical nodes that provide the functions of radio resource control (RRC), service data adaptation protocol (SDAP), and packet data convergence protocol (PDCP). The CU-CP 152 may be a logical node that provides the functions of the control plane portions of RRC and PDCP. The CU-UP 153 may be a logical node that provides the functions of the user plane portions of SDAP and PDCP.

According to various embodiments, the core network (e.g., 5GC 5th generation core) 154 may include at least one of an access and mobility management function (AMF) 155, a user plane function (UPF) 156, or a session management function (SMF) 157. The AMF 155 may provide functions for access and mobility management in units of the UE 160. The SMF 156 may provide session management functions. The UPF 156 may transfer the downlink data received from the data network to the UE 160 or transfer the uplink data received from the UE 160 to the data network. For example, the CU-CP 152 may be connected to the AMF 155 through an N2 interface (or an NGAP interface). The AMF 155 may be connected to the SMF 157 through an N11 interface. The CU-UP 153 may be connected to the UPF 153 through an N3 interface.

According to various embodiments, the RIC 101 may customize RAN functionality for service or regional resource optimization. The RIC 101 may provide at least one function among network intelligence (e.g., policy enforcement, handover optimization), resource assurance (e.g., radio-link management, advanced self-organized-network (SON)), and resource control (e.g., load balancing or slicing policy). The function (or an operation performed) associated with the RAN 150 that may be provided by the RIC 101 is not limited.

According to various embodiments, the RIC 101 may transmit and/or receive E2 messages 191 and 192 with the RAN 150. For example, the RIC 101 may be connected to the DU 151 through an E2-DU interface. For example, the RIC 101 may be connected to the CU-CP 152 through an E2-CP interface. For example, the RIC 101 may be connected to the CU-UP 153 through an E2-UP interface. At least one interface between the RIC 101 and the RAN 150 may be referred to as an E2 interface. Meanwhile, the RIC 101 is illustrated as being a device separate from the RAN 150, but this is merely an example, and the RIC 101 may be implemented as a device separate from the RAN 150 or may be implemented as a single device.

According to various embodiments, an E2 node (e.g., at least one of the DU 151, the CU-CP 152, or the CU-UP 153) of the RIC 101 may transmit and/or receive the E2 messages 191 and 192. The E2 node may include (or provide) an E2 node function. The E2 node function may be set based on a specific xApp (application S/W) installed in the RIC 101. If the function of the KPI monitor is provided, the KPI monitor collection S/W may be installed in the RIC 101. The E2 node may generate KPI parameters and may include an E2 node function of transferring the E2 message 191 including the KPI parameter to an E2 termination function positioned in the RIC 101. The E2 termination function positioned in the RIC 101 is the termination of the RIC 101 for the E2 message, and may interpret the E2 message transferred by the E2 node and then transfer the same to the xApp. The RIC 101 may provide information associated with the operation of the RAN 150 to the RAN 150 via the E2 message 192. The RIC 101 may deploy the xAPP, and the xAPP deployed in the RIC 101 may subscribe to the E2 node. The xAPP may receive the E2 message periodically or aperiodically from the subscribed E2 node. Meanwhile, it may be understood that at least some of the operations performed by the RIC 101 in the disclosure are performed by the deployed xApp. The xAPP may include at least one instruction to perform at least some of operations performed by the RIC 101 in the disclosure after being deployed. Alternatively, the operation performed by the electronic device in the disclosure may be performed by the RIC 101 and/or the RAN 150 (e.g., the DU 151).

FIG. 1B is a block diagram illustrating an example hardware configuration of an electronic device according to various embodiments.

According to various embodiments, an electronic device 102 may include at least one processor (e.g., including processing circuitry) 120, a storage device (e.g., memory) 130, and/or a communication module (e.g., including communication circuitry) 190. In one example, the electronic device 102 may be configured to perform operations for, e.g., the RAN 150 (or, DU 151), or may store at least one instruction for performing operations. In this case, the electronic device 102 may be a device (or system) for performing operations of the DU 151 (or for executing an application associated with the DU 151 or a Pod associated with the DU 151) in a C-RAN environment or an O-RAN environment. The electronic device 102 may execute a container (or virtual machine) of an application (or Pod) associated with the DU 151 on, e.g., Kubernetes orchestration, but its execution form is not limited. In another example, the electronic device 102 may be configured to perform operations for, e.g., the RIC 101, or may store at least one instruction for performing operations. In this case, the electronic device 102 may be a device (or system) for performing operations of the RIC 101 (or for executing an application associated with the RIC 101 or a Pod associated with the RIC 101) in an O-RAN environment. The electronic device 102 may execute a container (or virtual machine) of an application (or Pod) associated with the RIC 101 on, e.g., Kubernetes orchestration, but its execution form is not limited.

According to an embodiment, the processor 120 may include various processing circuitry and execute, e.g., software (e.g., a program) to control at least one other component (e.g., a hardware or software component) of the electronic device 102 connected with the processor 120 and may process or compute various data. The software may include, but is not limited to, e.g., an application, a Pod, or an xAPP. According to an embodiment, as at least part of data processing or computation, the processor 120 may store commands or data received from another component in the storage device 130, process commands or data stored in the storage device 130, and store the resultant data in the storage device 130. According to an embodiment, the processor 120 may include at least some of at least one central processing unit (CPU), at least one graphical processing unit (GPU), at least one application processor, at least one neural processing unit (NPU), a stream multiprocessor (SM), or a communication processor, but the type of the processor 120 is not limited. The neural network processing device may include a hardware structure specialized for processing an artificial intelligence model. The artificial intelligence model may include machine learning (e.g., reinforcement learning, supervised learning, unsupervised learning, or semi-supervised learning), but is not limited to the above-described examples. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure. It will be appreciated by one of ordinary skill in the art that the storage device 130 is not limited as long as it is a device capable of storing data, such as a disk (e.g., HDD). The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to various embodiments, the storage device 130 may store various data used by at least one component (e.g., the processor 120 and/or communication module 190) of the electronic device 102. The various data may include, for example, software and input data or output data for a command related thereto.

According to various embodiments, the communication module 190 may include various communication circuitry and transmit/receive data to/from other entities. For example, when the electronic device 102 is a device for performing the operation of the DU 151, the communication module 190 may transmit/receive data to/from the RU 161 and/or may transmit/receive data to/from the RIC 101. For example, when the electronic device 102 is a device for performing the operation of the RIC 101, the communication module 190 may transmit/receive data to/from an E2 entity including the DU 151. If data may be transmitted/received with the above-described entities, the type of the communication module 190a and/or the communication scheme supported by the communication module 190a is not limited.

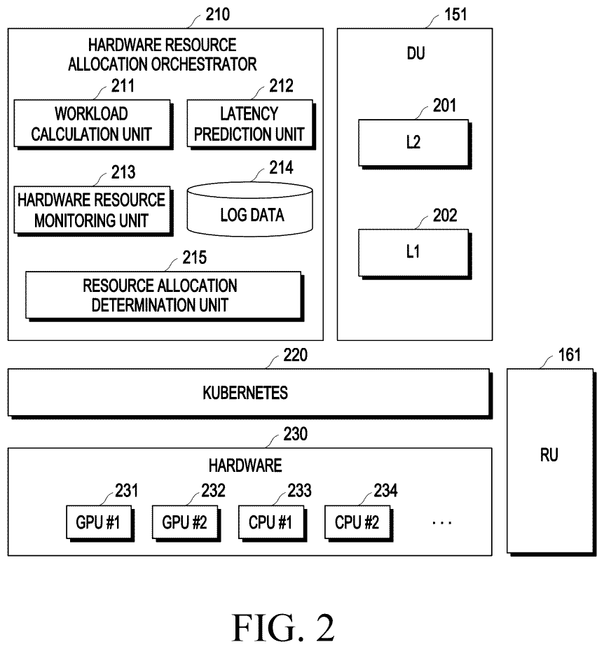

FIG. 2 is a block diagram illustrating an example configuration of an entity for hardware resource allocation, according to various embodiments.

According to various embodiments, an electronic device 102 may include (or execute) a hardware entity 230. For example, the hardware entity 230 may include at least one of the first GPU 231, the second GPU 232, the first CPU 233, or the second CPU 234, but the number and/or type thereof is not limited. Here, the first GPU 231 and the second GPU 232 may refer to two independent GPUs in one example, or may refer to different instances in one GPU in another example. Here, the first CPU 233 and the second CPU 234 may refer to two independent CPUs in one example, or may refer to different cores in one CPU in another example. It will be understood by one of ordinary skill in the art that hardware resources are not limited as long as they are units that may be independently computed (or isolated). Although FIG. 2 illustrates and/or describes that the hardware entity 230 includes resources for computation, this is merely an example, and the hardware entity 230 may include resources for storing data. For example, the Kubernetes orchestration 220 may execute an application (or Pod) based on a container (or a virtual machine) and, for the container, may allocate to at least one of the hardware resources 231, 232, 233, and 234. The allocation of the specific application (or Pod) by the Kubernetes orchestration 220 to the specific hardware resource may refer, for example, to, e.g., execution of an instruction corresponding to the specific application (or Pod) and/or that storage of data being performed by the specific hardware resource.

For example, the Kubernetes orchestration 220 may allocate an application (or Pod) of the hardware resource allocation orchestrator 210 to at least one hardware resource. The hardware resource allocation orchestrator 210 may allocate each of the plurality of physical channels of the network to at least some of the hardware resources 231, 232, 233, and 234. For example, the hardware resource allocation orchestrator 210 may allocate a physical downlink control channel (PDCCH) to the first GPU 231 for the first slot and may provide allocation information about the PDCCH to the DU 151. The DU 151 may perform processing of data associated with the PDCCH during a first slot using the first GPU 231. For example, the hardware resource allocation orchestrator 210 may allocate a PDCCH to the second GPU 232 for the second slot and may provide allocation information about the PDCCH to the DU 151. The DU 151 may perform processing of data associated with the PDCCH during the second slot using the second GPU 232. For example, the hardware resource allocation orchestrator 210 may allocate a physical downlink shared channel (PDSCH) to the first GPU 231 for the first slot and may provide allocation information about the PDSCH to the DU 151. The DU 151 may perform processing of data associated with the PDSCH during the first slot using the first GPU 231. As described above, the hardware resource allocation orchestrator 210 may allocate each of a plurality of physical channels for a specific slot to each of at least some of the hardware resources 231, 232, 233, and 234, and the DU 151 may perform an operation associated with each of the physical channels using the hardware resource identified based on the allocation information. The hardware resource allocation orchestrator 210 may be executed by, e.g., the electronic device 102, and an operation performed by the hardware resource allocation orchestrator 210 in the disclosure may be understood as being performed by the electronic device 102. Referring to FIG. 2, it is illustrated that the hardware resource allocation orchestrator 210 is executed on the Kubernetes orchestration 220 executing the DU 151, and this may correspond to the case where the electronic device 102 is an electronic device for executing the DU 151. Although not shown, it will be understood by one of ordinary skill in the art that the hardware resource allocation orchestrator 210 may be executed on a Kubernetes orchestration (not shown) executing the RIC 101, and in this case, the hardware resource allocation information may be provided to the DU 151 through the E2 interface.

According to various embodiments, the hardware resource allocation orchestrator 210 may include at least one of a workload calculation unit 211, a latency prediction unit 212, a hardware resource monitoring unit 213, log data 214, or a resource allocation determination unit 215. The workload calculation unit 211, the latency prediction unit 212, the hardware resource monitoring unit 213, the log data 214, and the resource allocation determination unit 215 are, e.g., entities included in the hardware resource allocation orchestrator 210, and may be implemented as, e.g., an instruction set or an independent application (or Pod). The log data 214 may refer to, e.g., an entity capable of reading log data included in a storage device defined in the hardware entity 230 and/or writing new log data.

According to various embodiments, the workload calculation unit 211 may calculate each of computation amounts corresponding to each of a plurality of physical channels in a specific slot. For example, the workload calculation unit 211 may calculate each of computation amounts corresponding to each of a plurality of physical channels in a specific slot, based on a control plane message provided from the L2 entity (or layer) 201 of the DU 151 to the RU 161. For example, the workload calculation unit 211 may identify the amount of radio resources allocated for a specific channel in a specific slot, based on the resource block RB and/or symbol of the specific physical channel included in the control plane message. The workload calculation unit 211 may calculate the computation amount for data processing of a specific channel based on the identified radio resource amount. The computation amount for data processing may be different for each physical channel, e.g., or may be set to be the same. As described above, the workload calculation unit 211 may calculate the computation amount for each of a plurality of physical channels in a specific slot. Meanwhile, the above-described slot unit is merely an example, and the time unit of the computation amount corresponding to each of the plurality of physical channels calculated by the workload calculation unit 211 is not limited.

As another example, the latency prediction unit 212 may calculate an computation amount corresponding to each of the plurality of physical channels, based on information stored in the log data 214. For example, the log data 214 may include association information between radio resource allocation information for the specific channel in the past and the computation amount when the radio resource allocation information is processed by the specific hardware. Table 1 shows an example of log data 214.

TABLE 1

| | radio resource allocation | |
|---|---|---|
| physics channel | amount | computation amount |
| PDCCH | R1 | A1 |
| PDCCH | R2 | A2 |
| PDSCH | R1 | A3 |
| PDSCH | R2 | A4 |

For example, the hardware resource allocation orchestrator 210 may store and/or manage past processing log as shown in Table 1. The workload calculation unit 211 may predict a computation amount for each physical channel for the instant slot based on log data 214 as shown in Table 1. For example, it is possible to store and/or manage a log that the computation amount of A1 was actually required to process the PDCCH of the radio resource allocation of R1, the computation amount of A2 was actually required to process the PDCCH of the radio resource allocation of R2, the computation amount of A3 was actually required to process the PDSCH of the radio resource allocation of R1, and the computation amount of A4 was actually required to process the PDSCH of the radio resource allocation of R2. The workload calculation unit 211 may predict the computation amount for each physical channel in the instant slot based on the log data 215. For example, when the radio resource of R1 is allocated to the PDCCH in the instant slot, the workload calculation unit 211 may predict the computation amount of A1 for the PDCCH in the instant slot based on the log data 215 shown in Table 1. Alternatively, if radio resources of R3, which are not included in the log data 215, are allocated to the PDCCH in the instant slot, e.g., the workload calculation unit 211 may estimate the computation amount for the PDCCH in the instant slot based on the log data 215 shown in Table 1. For example, the workload calculation unit 211 may predict the computation amount based on a linear relationship between the radio resource allocation and the computation amount, but it will be understood by one of ordinary skill in the art that the linear relationship is merely an example and the method for predicting the computation amount is not limited. As described above, the workload calculation unit 211 may identify the computation amount for each physical channel in a specific slot using the calculation based on the radio resource allocation amount for each physical channel and/or the existing log data 215. According to various embodiments, the hardware resource monitoring unit 213 may monitor the available computation amount of the hardware resources 231, 232, 233, and 234. Each of the hardware resources 231, 232, 233, and 234 may have a maximum available computation amount. For example, for hardware resources divided into physical units, there may be a maximum available computation amount corresponding to the corresponding device. For example, for hardware resources divided into logical units, there may be a maximum available computation amount defined by the electronic device 102. For example, when a multi-instance GPU (MIG) function is executed, the maximum available computation amount may be set according to constraints on hardware resources for each instance. Meanwhile, at least some of the hardware resources 231, 232, 233, and 234 may perform other types of operations in addition to the operations associated with the physical channel. Accordingly, the available computation amount of each of the hardware resources 231, 232, 233, and 234 may be changed in real time, and the hardware resource monitoring unit 213 may monitor the available computation amount of the hardware resources 231, 232, 233, and 234 in real time.

According to various embodiments, the resource allocation determination unit 215 may identify the computation amount of each of the plurality of physical channels provided from the workload calculation unit 211. The resource allocation determination unit 215 may identify the available computation amount of the plurality of hardware resources 231, 232, 233, and 234 provided from the hardware resource monitoring unit 213. The resource allocation determination unit 215 may allocate each of the plurality of physical channels to at least some of the plurality of hardware resources 231, 232, 233, and 234, based on the computation amount of each of the plurality of physical channels and the available computation amount of the plurality of hardware resources 231, 232, 233, and 234. For example, the resource allocation determination unit 215 may allocate each of the physical channels so that the available computation amount of the specific hardware resource is larger than the computation amount of the specific physical channel.

In another example, the resource allocation determination unit 215 may allocate each of the plurality of physical channels to at least some of the plurality of hardware resources 231, 232, 233, and 234 based on latency. For example, the resource allocation determination unit 215 may identify a plurality of allocation policies based on the computation amount of each of the plurality of physical channels and the available computation amount of the plurality of hardware resources 231, 232, 233, and 234. The allocation policy may refer to a policy in which each of a plurality of physical channels is allocated. As described above, physical channels may be allocated so that the available computation amount of the specific hardware resource is larger than the computation amount of the specific physical channel, and accordingly, a plurality of allocation policies may be identified. The latency prediction unit 212 may predict latency for each of the plurality of allocation policies. For example, the latency prediction unit 212 may calculate the computation amount corresponding to each of the plurality of physical channels, based on information stored in the log data 214. For example, the log data 214 may include association information between the computation amount for the specific channel in the past and latency when the same is processed by the specific hardware. Table 2 shows an example of log data 214.

TABLE 2

| physics channel | hardware resources | computation amount | latency |
|---|---|---|---|
| PDCCH | first GPU | A1 | B1 |
| PDCCH | second GPU | A2 | B2 |
| PDCCH | first CPU | A3 | B3 |
| PDSCH | first GPU | A4 | B4 |

For example, the hardware resource allocation orchestrator 210 may store and/or manage past processing log as shown in Table 2. The latency prediction unit 212 may predict the computation amount for each allocation policy for the instant slot based on the log data 214 as shown in Table 2. For example, it is assumed that allocating the PDCCH of the computation amount of A5 to the first GPU is determined as a first allocation policy, and allocating the PDCCH of the computation amount of A5 to the second GPU is determined as a second allocation policy. When the PDCCH is the computation amount of A1 in the log data 214, the latency prediction unit 212 may predict latency (e.g., B5) for the computation amount of A5 of the first allocation policy, based on the fact that the latency when processed by the first GPU is B1. When the PDCCH is the computation amount of A2 in the log data 214, the latency prediction unit 212 may predict latency (e.g., B6) for the computation amount of A5 of the first allocation policy, based on the fact that the latency when processed by the second GPU is B2. For example, the latency prediction unit 212 may predict the latency based on a linear relationship between the computation amount and the latency, but it will be understood by one of ordinary skill in the art that the linear relationship is merely an example and the prediction method for the latency is not limited. The resource allocation determination unit 215 may receive latencies (e.g., B5 and B6) for each allocation policy from the latency prediction unit 212, and may select one allocation policy based on a result of comparing the latencies (e.g., B5 and B6). Meanwhile, in the above description, an example of one physical channel of the PDCCH has been described, but this is merely an example, and the latency prediction unit 212 may predict latency for each of latency for a plurality of physical channels. In this case, the resource allocation determination unit 215 may select any one of the plurality of allocation policies based on the latency of each of the plurality of physical channels, or may select any one of the plurality of allocation policies based on the latency of any one physical channel among the plurality of physical channels. According to various embodiments, the resource allocation determination unit 215 may determine the allocation policy and provide the same to the L1 entity 202 of the DU 151. The L1 entity 202 may process data for each physical channel using a corresponding hardware resource based on the provided allocation policy. Data processed based on the corresponding hardware resource may be transmitted/received to/from the RU 151, and thus a network operation may be performed.

Further, although not illustrated as described above, the hardware resource allocation orchestrator 210 may be executed by the RIC 101. The RIC 101 may receive, e.g., a control plane message (or radio resource allocation information for a physical channel in the control plane message) from the DU 151 through the E2 interface. The hardware resource allocation orchestrator 210 executed on the RIC 101 may determine an allocation policy for a specific slot (or another time unit) based on at least some of the above-described embodiments, based on the provided control plane message (or radio resource allocation information for the physical channel in the control plane message). The RIC 101 may provide the allocation policy to the DU 151 through the E2 interface, and the DU 151 may process the data for each physical channel using the corresponding hardware resource according to the received allocation policy.

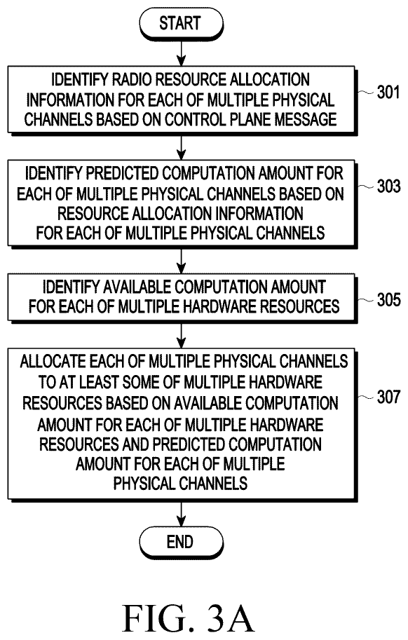

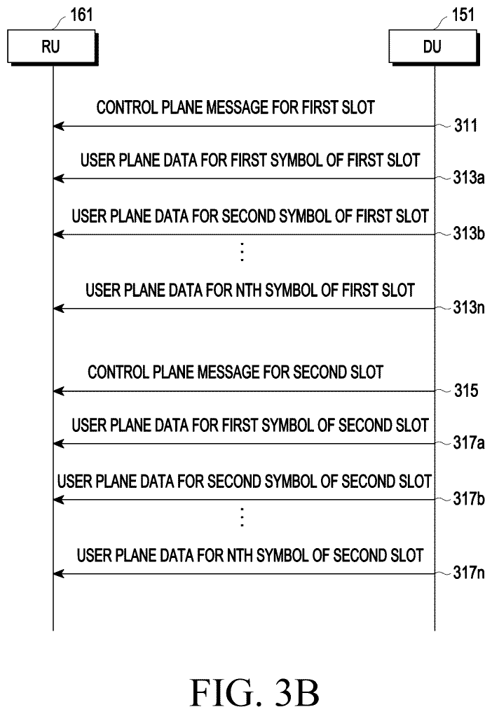

FIG. 3A is a flowchart illustrating example operations of an electronic device according to various embodiments. FIG. 3A is described with reference to FIGS. 3B and 4. FIG. 3B is a signal flow diagram illustrating example transmission/reception of a control plane message and user plane data, according to various embodiments. FIG. 4 is a diagram illustrating example allocation of a hardware resource of physical channels according to various embodiments.

According to various embodiments, the electronic device 102 (e.g., the processor 120) may identify radio resource allocation information for each of a plurality of physical channels based on the control plane message in operation 301. For example, the electronic device 102 may identify radio resource allocation information for each of the plurality of physical channels, based on triggering of a new slot (or detection of a trigger event) in the L2 entity 201. For example, as shown in FIG. 3B, in operation 311, the DU 151 may provide a control plane message for the first slot to the RU 161. The control plane message may include information for radio resource allocation, e.g., numPrbc and/or numSymbol in sectioned. The electronic device 102 may identify radio resource allocation information (e.g., the number of RBs and/or the number of symbols) for each of the plurality of physical channels in the first slot, based on the control plane message. Thereafter, in operations 313a, 313b, and 313n, the DU 161 may provide user plane data for the first symbol, the second symbol, and the nth symbol (e.g., n is 14) of the first slot to the RU 161. In operation 315, the DU 151 may provide a control plane message for the second slot to the RU 161. Thereafter, in operations 317a, 317b, and 317n, the DU 161 may provide user plane data for the first symbol, the second symbol, and the nth symbol (e.g., n is 14) of the second slot to the RU 161. The electronic device 102 may identify radio resource allocation information (e.g., the number of RBs and/or the number of symbols) for each of the plurality of physical channels in the second slot, based on the control plane message. As described above, the electronic device 102 may identify radio resource allocation information for each of the plurality of physical channels for each slot.

According to various embodiments, in operation 303, the electronic device 102 may identify the predicted computation amount for each of the plurality of physical channels, based on the radio resource allocation information for each of the plurality of physical channels. For example, the electronic device 102 may identify the predicted computation amount for each of the plurality of physical channels, based on the calculation using the radio resource allocation information for each of the plurality of physical channels. The electronic device 102 may identify the predicted computation amount for each of the plurality of physical channels, based on log data including the relationship between the radio resource allocation information for each of the plurality of physical channels and the computation amount. A method for identifying a predicted computation amount based on calculation and/or a method for identifying a predicted computation amount based on log data has been described with reference to FIG. 2, and thus a description thereof is not repeated.

According to various embodiments, in operation 305, the electronic device 102 may identify an available computation amount for each of the plurality of hardware resources. In operation 307, the electronic device 102 may allocate each of the plurality of physical channels to at least some of the plurality of hardware resources, based on the available computation amount for each of the plurality of hardware resources and the predicted computation amount for each of the plurality of physical channels. For example, the electronic device 102 may allocate each of the plurality of physical channels to at least some of the plurality of hardware resources so that the computation amount larger than an available computation amount is not allocated to any hardware resource. For example, in the example of FIG. 4, the electronic device 102 may allocate the PDCCH 401 to the first GPU 231, the PDSCH 402 to the first GPU 231, and the PRACH 403 to the first CPU 233. For example, the electronic device 102 may allocate the PDCCH 401 and the PDSCH 402 to the first GPU 231, based on the predicted computation amount of the PDCCH 401 and the predicted computation amount of the PDSCH 402 being smaller than the available computation amount of the first GPU 231.

According to various embodiments, the electronic device 102 may allocate each of the plurality of physical channels to at least some of the plurality of hardware resources based on latency. For example, as described with reference to FIG. 2, the electronic device 102 may identify latency for each of the plurality of physical channels corresponding to the allocation policy. The electronic device 102 may allocate each of the plurality of physical channels to at least some of the plurality of hardware resources, based on whether the latency for each of the plurality of physical channels meets a latency limit. For example, in the example of FIG. 4, the sum of the computation amounts of the PDCCH 401, the PDSCH 402, and the PRACH 403 may be smaller than the available computation amount of the first GPU 231. Accordingly, it may be relatively efficient to allocate the PDCCH 401, the PDSCH 402, and the PRACH 403 to the first GPU 231. The electronic device 102 may identify latency corresponding to each of the PDCCH 401, the PDSCH 402, and the PRACH 403 when allocating the PDCCH 401, the PDSCH 402, and the PRACH 403 to the first GPU 231. Further, a latency limit corresponding to each of the PDCCH 401, the PDSCH 402, and the PRACH 403 may be set, and there is no limit to the method and/or condition of setting the latency limit. When the PDCCH 401, the PDSCH 402, and the PRACH 403 are allocated to the first GPU 231, it may be identified that at least some of the latencies respectively corresponding to the PDCCH 401, the PDSCH 402, and the PRACH 403 exceed the latency limit corresponding to each of the PDCCH 401, the PDSCH 402, and the PRACH 403. In this case, the electronic device 102 may not allocate the PDCCH 401, the PDSCH 402, and the PRACH 403 to the first GPU 231. However, when the latency limit is not met in all allocation policies, the electronic device 102 may select any one allocation policy according to the priority, which is described below.

In various embodiments, the electronic device 102 may be configured to allocate each of the plurality of sub-physical channels included in one physical channel to hardware resources. In the above-described example, the electronic device 102 has been described as allocating one physical channel to one hardware resource, but this is merely an example, and in various embodiments, the plurality of sub-physical channels of one physical channel may be allocated to different hardware resources, respectively. For example, the electronic device 102 may allocate the PUSCH corresponding to the first UE to the first hardware resource in one slot, and may allocate the PUSCH corresponding to the second UE to the second hardware resource. Meanwhile, it is understood to discern sub-physical channels for each UE, and the method for discerning the plurality of sub-physical channels for one physical channel is not limited.

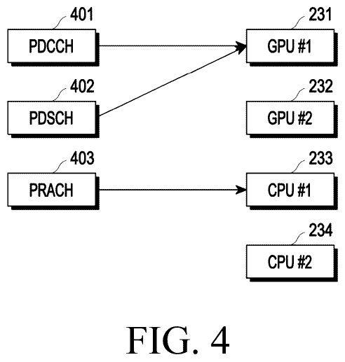

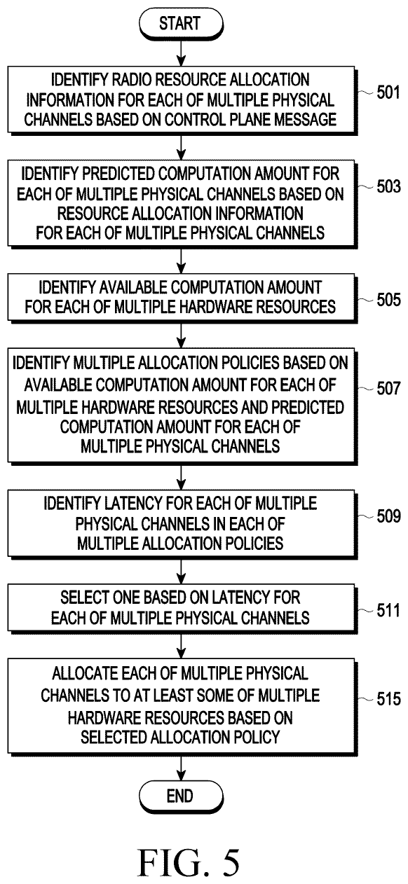

FIG. 5 is a flowchart illustrating example operations of an electronic device according to various embodiments. FIG. 5 is described with reference to FIG. 6. FIG. 6 is a diagram illustrating example allocation of a hardware resource of physical channels according to various embodiments.

According to various embodiments, the electronic device 102 (e.g., the processor 120) may identify radio resource allocation information for each of a plurality of physical channels based on the control plane message in operation 501. The electronic device 102 may identify radio resource allocation information for each of the plurality of physical channels, based on numPrbc and/or numSymbol in sectioned included in the control plane message. In operation 503, the electronic device 102 may identify the predicted computation amount for each of the plurality of physical channels, based on the radio resource allocation information for each of the plurality of physical channels. For example, the electronic device 102 may identify the predicted computation amount for each of the plurality of physical channels, based on the calculation using the radio resource allocation information for each of the plurality of physical channels. The electronic device 102 may identify the predicted computation amount for each of the plurality of physical channels, based on log data including the relationship between the radio resource allocation information for each of the plurality of physical channels and the computation amount. According to various embodiments, in operation 505, the electronic device 102 may identify an available computation amount for each of the plurality of hardware resources.

According to various embodiments, in operation 507, the electronic device 102 may identify a plurality of allocation policies based on the available computation amount for each of the plurality of hardware resources and the predicted computation amount for each of the plurality of physical channels.

In operation 509, the electronic device 102 may identify latency for each of the plurality of physical channels in each of the plurality of allocation policies. For example, the electronic device 102 may identify an allocation policy capable of allocating each of the plurality of physical channels to at least some of the plurality of hardware resources so that the computation amount larger than the available computation amount is not allocated to any hardware resource. For example, referring to FIG. 6, the electronic device 102 may identify the first allocation policy that allocates the PDCCH 401 to the first GPU 231, the PDSCH 402 to the first GPU 231, and the PRACH 403 to the first CPU 233. In the first allocation policy, the electronic device 102 may identify that each of the plurality of physical channels may be allocated to at least some of the plurality of hardware resources so that the computation amount larger than an available computation amount is not allocated to any hardware resource. The electronic device 102 may identify latency (e.g., A1 μs, B1 μs, and C1 μs) corresponding to each of the plurality of physical channels 401, 402, and 403 in the first allocation policy. For example, as described with reference to FIG. 2, the electronic device 102 may identify latencies (e.g., A1 μs, B1 μs, and C1 μs) respectively corresponding to the plurality of physical channels 401, 402, and 403 based on log data including association information between the computation amount and the latency, but the identification method is not limited. The electronic device 102 may identify the second allocation policy that allocates the PDCCH 401 to the first GPU 231, the PDSCH 402 to the second GPU 232, and the PRACH 403 to the first CPU 233. In the second allocation policy, the electronic device 102 may identify that each of the plurality of physical channels may be allocated to at least some of the plurality of hardware resources so that the computation amount larger than an available computation amount is not allocated to any hardware resource. The electronic device 102 may identify latency (e.g., A2 μs, B2 μs, and C2 μs) corresponding to each of the plurality of physical channels 401, 402, and 403 in the second allocation policy. In FIG. 6, it is illustrated that the electronic device 102 has identified two allocation policies, but this is an example, and the number of allocation policies is not limited.

According to various embodiments, in operation 511, the electronic device 102 may select one based on latency for each of the plurality of physical channels.

In an example, the electronic device 102 may select an allocation policy in which latencies respectively corresponding to the plurality of physical channels 401, 402, and 403 meet latency limits respectively corresponding to the plurality of physical channels 401, 402, and 403. For example, latency limits respectively corresponding to the plurality of physical channels 401, 402, and 403 may be set to TH_PDCCH, TH_PDSCH, and TH_PRACH, but there is no limitation on how to set the latency limits. Meanwhile, it has been described that the latency limits for the physical channel are different, but this is merely an example, and the latency limits of at least two physical channels among the physical channels may be the same. The electronic device 102 may identify whether each of the latencies (e.g., A1 μs, B1 μs, and C1 μs) respectively corresponding to the plurality of physical channels 401, 402, and 403 in the first allocation policy is less than or equal to each of the latency limits TH_PDCCH, TH_PDSCH, and TH_PRACH. For example, when each of the latencies (e.g., A1 μs, B1 μs, and C1 μs) respectively corresponding to the plurality of physical channels 401, 402, and 403 in the first allocation policy is less than or equal to each of the latency limits TH_PDCCH, TH_PDSCH, and TH_PRACH, the electronic device 102 may identify the first allocation policy as an available allocation policy. When at least one of latencies (e.g., A2 μs, B2 μs, and C2 μs) respectively corresponding to the plurality of physical channels 401, 402, and 403 in the second allocation policy exceeds a corresponding latency limit, the electronic device 102 may identify the second allocation policy as an unavailable allocation policy. In this case, the electronic device 102 may select the first allocation policy meeting the latency limit from among the plurality of allocation policies.

In an example, it may be identified that there are a plurality of allocation policies in which the latencies of all the physical channels meet the corresponding latency limits. In this case, the electronic device 102 may select any one allocation policy based on the priorities of the plurality of allocation policies. In an example, the electronic device 102 may select an allocation policy having a minimum amount of used hardware resources (or energy consumption) from among the plurality of allocation policies. For example, referring to FIG. 6, it is assumed that each of the latencies (e.g., A1 μs, B1 μs, and C1 μs) respectively corresponding to the plurality of physical channels 401, 402, and 403 in the first allocation policy is less than or equal to each of the latency limits TH_PDCCH, TH_PDSCH, and TH_PRACH, and each of the latencies (e.g., A2 μs, B2 μs, and C2 μs) respectively corresponding to the plurality of physical channels 401, 402, and 403 in the second allocation policy is less than or equal to each of the latency limits TH_PDCCH, TH_PDSCH, and TH_PRACH. In this case, the electronic device 102 may identify that both the first allocation policy and the second allocation policy meet the latency limits. Meanwhile, according to the first allocation policy, the first GPU 231 and the first CPU 233 may be used, and according to the second allocation policy, the first GPU 231, the second GPU 232, and the first CPU 233 may be used. Based on the number (or energy consumption) of hardware resources used according to the first allocation policy being smaller than the number (or energy consumption) of hardware resources used according to the second allocation policy, the electronic device 102 may select the first allocation policy. In another example, the electronic device 102 may select an allocation policy having a minimum latency sum among the plurality of allocation policies. In another example, the electronic device 102 may select an allocation policy (or an allocation policy having minimum latency) in which latency of a physical channel having a high priority (e.g., a control channel such as a PDCCH or a PUCCH) meets a latency limit among the plurality of allocation policies. The electronic device 102 may select one of the plurality of allocation policies based on the above-described various selection conditions or based on a combination of at least two or more.

In an example, an allocation policy in which latency limits of all physical channels meet corresponding latency limits may not be identified. In this case, the electronic device 102 may select any one of the plurality of allocation policies that do not meet the latency limit. In one example, the electronic device 102 may select an allocation policy having a minimum used hardware resource (or a minimum energy consumption) from among the plurality of allocation policies that do not meet the latency limit. For example, referring to FIG. 6, it is assumed that at least one of the latencies (e.g., A1 μs, B1 μs, and C1 μs) respectively corresponding to the plurality of physical channels 401, 402, and 403 in the first allocation policy does not meet the latency limit, and at least one of the plurality of physical channels 401, 402, and 403 in the second allocation policy does not meet the latency limit. In this case, the electronic device 102 may identify that neither the first allocation policy nor the second allocation policy meets the latency limit. Meanwhile, according to the first allocation policy, the first GPU 231 and the first CPU 233 may be used, and according to the second allocation policy, the first GPU 231, the second GPU 232, and the first CPU 233 may be used. Based on the number (or energy consumption) of hardware resources used according to the first allocation policy being smaller than the number (or energy consumption) of hardware resources used according to the second allocation policy, the electronic device 102 may select the first allocation policy. In another example, the electronic device 102 may select an allocation policy having a minimum latency sum among the plurality of allocation policies that do not meet the latency limit. In another example, the electronic device 102 may select an allocation policy (or an allocation policy having minimum latency) in which latency of a physical channel having a high priority (e.g., a control channel such as a PDCCH or a PUCCH) meets a latency limit among the plurality of allocation policies that do not meet the latency limit. The electronic device 102 may select one of the plurality of allocation policies based on the above-described various selection conditions or based on a combination of at least two or more.

According to various embodiments, in operation 515, the electronic device 102 may allocate each of the plurality of physical channels to at least some of the plurality of hardware resources based on the selected allocation policy. Information related to hardware resource allocation for each of the plurality of physical channels may be provided to the DU 161, and the DU 161 may perform data processing for each of the plurality of physical channels using a corresponding hardware resource, based on the hardware resource allocation information.

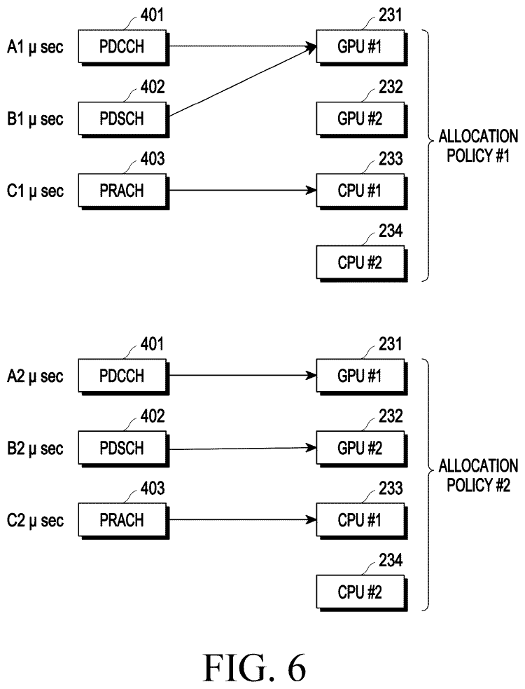

FIG. 7 is a flowchart illustrating example operations of an electronic device according to various embodiments.

According to various embodiments, in operation 701, the electronic device 102 (e.g., the processor 120) may identify a plurality of allocation policies based on the available computation amount for each of the plurality of hardware resources and the predicted computation amount for each of the plurality of physical channels. For example, the electronic device 102 may identify an allocation policy capable of allocating each of the plurality of physical channels to at least some of the plurality of hardware resources so that the computation amount larger than the available computation amount is not allocated to any hardware resource.

In operation 703, the electronic device 102 may identify an allocation policy having latencies that meet all of the time constraints for each of the plurality of physical channels among the plurality of allocation policies. For example, the electronic device 102 may identify latency for each of the plurality of physical channels of each of the allocation policies. As described above, latency limits may be set for the plurality of physical channels, which may be referred to as time constraints. The electronic device 102 may identify, e.g., an allocation policy in which each of latencies of all the physical channels meets the time constraints. Meanwhile, in another example, the electronic device 102 may identify an allocation policy in which at least one specific physical channel meets a time constraint, rather than all the of the plurality of physical channels.

According to various embodiments, in operation 705, the electronic device 102 may identify whether there are a plurality of identified allocation policies. If only one allocation policy is identified (No in operation 705), the electronic device 102 may select the one allocation policy in operation 707. If a plurality of allocation policies are identified (Yes in operation 705), the electronic device 102 may select the allocation policy having the highest priority in operation 709. In an example, the electronic device 102 may select an allocation policy having a minimum amount of used hardware resources (or energy consumption) from among the plurality of allocation policies. In another example, the electronic device 102 may select an allocation policy having a minimum latency sum among the plurality of allocation policies. In another example, the electronic device 102 may select an allocation policy (or an allocation policy having minimum latency) in which latency of a physical channel having a high priority (e.g., a control channel such as a PDCCH or a PUCCH) meets a latency limit among the plurality of allocation policies. The electronic device 102 may select one of the plurality of allocation policies based on the above-described various selection conditions or based on a combination of at least two or more.

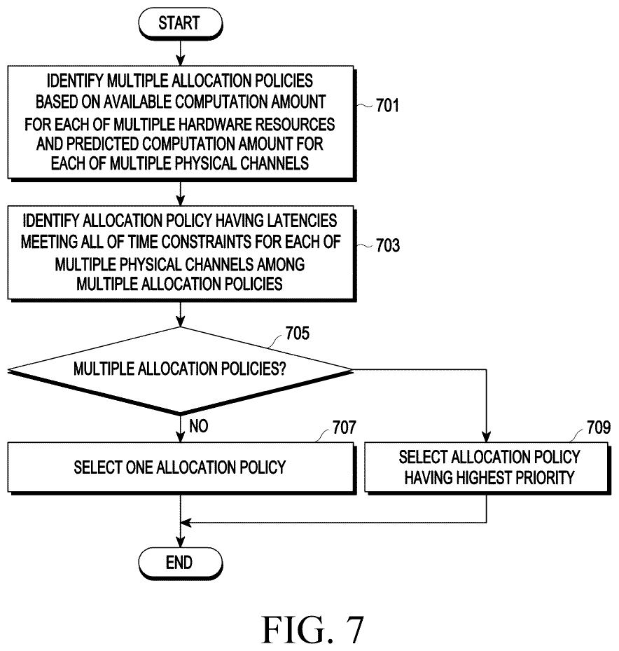

FIG. 8 is a flowchart illustrating example operations of an electronic device according to various embodiments.

According to various embodiments, in operation 801, the electronic device 102 (e.g., the processor 120) may identify a plurality of allocation policies based on the available computation amount for each of the plurality of hardware resources and the predicted computation amount for each of the plurality of physical channels. For example, the electronic device 102 may identify an allocation policy capable of allocating each of the plurality of physical channels to at least some of the plurality of hardware resources so that the computation amount larger than the available computation amount is not allocated to any hardware resource. In operation 803, the electronic device 102 may select at least one physical channel based on the priority among the plurality of physical channels. In an example, the electronic device 102 may select at least one default physical channel (e.g., a control channel such as a PDCCH or a PUCCH), but there is no limitation on the type of physical channel in which a relatively high priority is set. In operation 805, the electronic device 102 may identify latencies for each of the plurality of physical channels for the selected at least one physical channel. For example, when a PDCCH is selected, the electronic device 102 may identify latency for the PDCCH of each of the plurality of allocation policies. In operation 807, the electronic device 102 may select one allocation policy based on the identified latency. For example, when the PDCCH is selected, the electronic device 102 may select an allocation policy having a latency that meets a latency limit of the PDCCH. When the PDCCH is selected, the electronic device 102 may select an allocation policy having the lowest latency of the PDCCH. When there are the plurality of allocation policies having the same latency for the physical channel having the highest priority, the electronic device 102 may select one of the plurality of allocation policies based on the latency for the physical channel having the next priority.

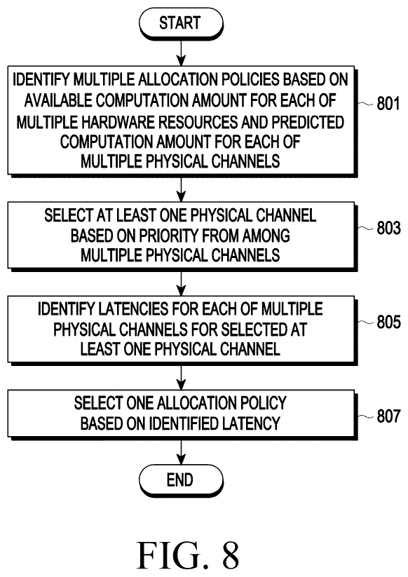

FIG. 9 is a flowchart illustrating example operations of an electronic device according to various embodiments.

According to various embodiments, the electronic device 102 (e.g., the processor 120) may identify radio resource allocation information for each of a plurality of physical channels based on the control plane message in operation 901. The electronic device 102 may identify radio resource allocation information (e.g., the number of RBs and/or the number of symbols) for each of the plurality of physical channels.

According to various embodiments, in operation 903, the electronic device 102 may identify the predicted computation amount for each of the plurality of physical channels, based on the radio resource allocation information for each of the plurality of physical channels and additional information. As described above, the electronic device 102 may identify the predicted computation amount for each of the plurality of physical channels, based on the calculation using the radio resource allocation information for each of the plurality of physical channels. The electronic device 102 may identify the predicted computation amount for each of the plurality of physical channels, based on log data including the relationship between the radio resource allocation information for each of the plurality of physical channels and the computation amount. The electronic device 102 may additionally consider the additional information and identify the predicted calculation amount for each of the plurality of physical channels. In an example, the electronic device 102 may identify the predicted calculation amount for each of the plurality of physical channels by considering the number of antennas used as the additional information. In one example, the electronic device 102 may identify the predicted computation amount for each of the plurality of physical channels by considering the number of layers as the additional information. In one example, the electronic device 102 may identify the predicted computation amount for each of the plurality of physical channels by considering the number of UEs connected to the network as the additional information. According to various embodiments, the electronic device 102 may identify the predicted computation amount for each of the plurality of physical channels by further considering a combination of two or more of the above-described additional information.

According to various embodiments, in operation 905, the electronic device 102 may identify an available computation amount for each of the plurality of hardware resources. In operation 907, the electronic device 102 may allocate each of the plurality of physical channels to at least some of the plurality of hardware resources, based on the available computation amount for each of the plurality of hardware resources and the predicted computation amount for each of the plurality of physical channels. For example, the electronic device 102 may allocate each of the plurality of physical channels to at least some of the plurality of hardware resources so that the computation amount larger than an available computation amount is not allocated to any hardware resource. The electronic device 102 may allocate each of the plurality of physical channels to at least some of the plurality of hardware resources based on latency. For example, as described with reference to FIG. 2, the electronic device 102 may identify latency for each of the plurality of physical channels corresponding to the allocation policy. The electronic device 102 may allocate each of the plurality of physical channels to at least some of the plurality of hardware resources, based on whether the latency for each of the plurality of physical channels meets a latency limit. It will be appreciated by one of ordinary skill in the art that the operation of identifying the predicted computation amount for each of the plurality of physical channels based on the radio resource allocation information according to various embodiments may be replaced with the operation of identifying the predicted computation amount for each of the plurality of physical channels based on the radio resource allocation information and at least one piece of additional information.

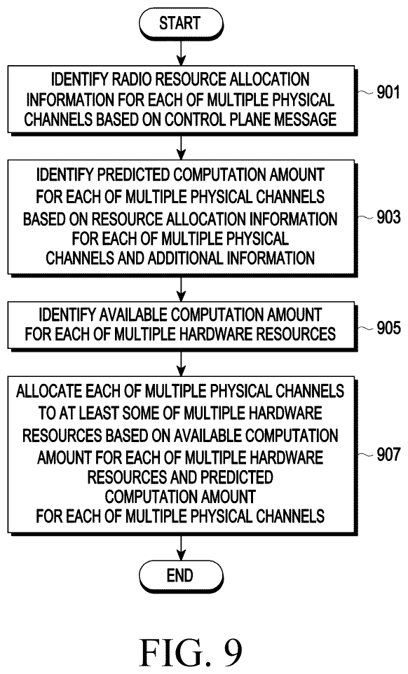

FIG. 10 is a diagram illustrating example allocation of a physical channel according to a comparative example and allocation of a physical channel according to various embodiments, for comparison with various embodiments.

The physical channel allocation policy according to the comparative example may be, e.g., fixedly allocating the uplink channel 1003 among the physical channels to the GPU 1001, and fixedly allocating the downlink channel 1004 to the CPU 1002. Meanwhile, uplink traffic may increase and downlink traffic may decrease. In this case, a relatively large number of idle resources may be secured in the CPU 1002 due to a decrease in downlink traffic, and a shortage of idle resources of the GPU 1001 may occur due to an increase in uplink traffic. According to the comparative example, the idle resources of the CPU 1002 may not be used according to the fixed allocation policy, and thus the efficiency of the hardware resource may be reduced. The computation amount of the uplink 1003 may exceed the available computation amount of the GPU 1001. In the electronic device 102 according to various embodiments, at least one first physical channel 1003a of the uplink 1003 may be allocated to the GPU 1001, and at least one second physical channel 1003b may be allocated to the CPU 1002. As described above, the electronic device 102 may predict the computation amount for each of the physical channels, and may allocate hardware resources to each of the plurality of physical channels based thereon. Accordingly, the electronic device 102 may allocate at least one first physical channel 1003a to the GPU 1001 and at least one second physical channel 1003b to the CPU 1002.

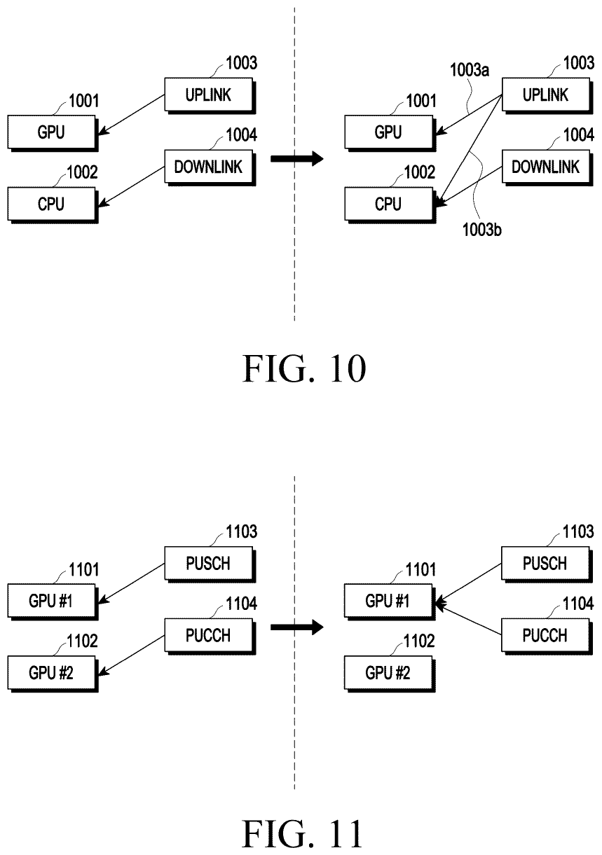

FIG. 11 is a diagram illustrating example allocation of a physical channel according to a comparative example and allocation of a physical channel according to various embodiments, for comparison with various embodiments.

The physical channel allocation policy according to the comparative example may be, e.g., fixedly allocating the PUSCH 1103 to the first GPU 1101, and fixedly allocating the PUCCH 1104 to the second GPU 1102. Meanwhile, in the comparative example, even when the total traffic of the PUSCH 1103 and the PUCCH 1104 is relatively low, both GPUs 1101 and 1102 (or GPU instances) should be driven. The electronic device 102 according to various embodiments may allocate both the PUSCH 1103 and the PUCCH 1104 to the first GPU 1101. As described above, the electronic device 102 may predict the computation amount for each of the physical channels, and may allocate hardware resources to each of the plurality of physical channels based thereon. Accordingly, the electronic device 102 may allocate both the PUSCH 1103 and the PUCCH 1104 to the first GPU 1101, and in this case, the second GPU 1102 may be in an idle state. Alternatively, the second GPU 1102 may be used for other operations (e.g., training (e.g., reinforcement training) of an AI model for calculation of computation amount and/or latency) other than network data processing.

According to various example embodiments, a method for operating an electronic device may comprise: identifying radio resource allocation information for each of a plurality of physical channels in a first slot, based on a control plane message including radio resource allocation information for the first slot, identifying each of predicted computation amounts for each of the plurality of physical channels, based on the radio resource allocation information for each of the plurality of physical channels, identifying an available computation amount for each of a plurality of hardware resources supported by the electronic device, and allocating each of the plurality of physical channels to at least some of the plurality of hardware resources, based on the available computation amount for each of the plurality of hardware resources and the predicted computation amount for each of the plurality of physical channels.

According to various example embodiments, the radio resource allocation information for each of the plurality of physical channels in the first slot may include the number of resource block RBs and/or the number of symbols for each of the plurality of physical channels.

According to various example embodiments, identifying each of the predicted computation amounts for each of the plurality of physical channels based on the radio resource allocation information for each of the plurality of physical channels may include identifying each of the predicted computation amounts for each of the plurality of physical channels based on performing calculation using the number of RBs and/or the number of symbols for each of the plurality of physical channels.

According to various example embodiments, identifying each of the predicted computation amounts for each of the plurality of physical channels based on the radio resource allocation information for each of the plurality of physical channels may include identifying each of the predicted computation amounts for each of the plurality of physical channels using association information between the number of RBs and/or the number of symbols for each of the plurality of physical channels and the number of RBs and/or the number of symbols for each of the plurality of physical channels in a past and the computation amount.

According to various example embodiments, identifying each of the predicted computation amounts for each of the plurality of physical channels based on the radio resource allocation information for each of the plurality of physical channels may include identifying each of predicted computation amounts for each of the plurality of physical channels, based on the radio resource allocation information for each of the plurality of physical channels and at least one piece of additional information. The at least one piece of additional information may include at least one of the number of antennas used to transmit and/or receive the plurality of physical channels, the number of layers of the plurality of physical channels, or the number of user equipments (UEs) connected to the electronic device.

According to various example embodiments, allocating each of the plurality of physical channels to at least some of the plurality of hardware resources, based on the available computation amount for each of the plurality of hardware resources and the predicted computation amount for each of the plurality of physical channels may include allocating each of the plurality of physical channels to at least some of the plurality of hardware resources so that an available computation amount of each of the at least some of the plurality of hardware resources is equal to or larger than a sum of computation amounts of at least one allocated physical channel.

According to various example embodiments, allocating each of the plurality of physical channels to at least some of the plurality of hardware resources, based on the available computation amount for each of the plurality of hardware resources and the predicted computation amount for each of the plurality of physical channels may include: identifying latency for each of the plurality of physical channels based on the predicted computation amount for each of the plurality of physical channels, and allocating each of the plurality of physical channels to at least some of the plurality of hardware resources, based on the available computation amount for each of the plurality of hardware resources, the predicted computation amount for each of the plurality of physical channels, and the latency for each of the plurality of physical channels.

According to various example embodiments, allocating each of the plurality of physical channels to at least some of the plurality of hardware resources, based on the available computation amount for each of the plurality of hardware resources, the predicted computation amount for each of the plurality of physical channels, and the latency for each of the plurality of physical channels may include: identifying the plurality of allocation policies so that an available computation amount of each of at least some of the plurality of hardware resources is equal to or larger than a sum of computation amounts of at least one allocated physical channel, and selecting one of the plurality of allocation policies based on the latency for each of the plurality of physical channels of each of the plurality of allocation policies.

According to various example embodiments, selecting one of the plurality of allocation policies based on the latency for each of the plurality of physical channels of each of the plurality of allocation policies may include selecting the one allocation policy in which the latency for each of the plurality of physical channels is less than or equal to a latency limit for each of the plurality of physical channels.

According to various example embodiments, selecting one of the plurality of allocation policies based on the latency for each of the plurality of physical channels of each of the plurality of allocation policies may include, based on there being the plurality of candidate allocation policies in which the latency for each of the plurality of physical channels is less than or equal to the latency limit for each of the plurality of physical channels, selecting the one allocation policy from among the plurality of candidate allocation policies.

According to various example embodiments, selecting one of the plurality of allocation policies based on the latency for each of the plurality of physical channels of each of the plurality of allocation policies may include, based on there being the plurality of candidate allocation policies in which the latency for each of the plurality of physical channels is less than or equal to the latency limit for each of the plurality of physical channels, selecting an allocation policy using a minimum hardware resource from among the plurality of candidate allocation policies.

According to various example embodiments, selecting one of the plurality of allocation policies based on the latency for each of the plurality of physical channels of each of the plurality of allocation policies may include, based on there being the plurality of candidate allocation policies in which the latency for each of the plurality of physical channels is less than or equal to the latency limit for each of the plurality of physical channels, selecting an allocation policy having a minimum latency of a designated physical channel from among the plurality of candidate allocation policies.

According to various example embodiments, an electronic device may comprise: memory, and at least one processor, comprising processing circuitry, operatively connected to the memory. The memory may store at least one instruction, wherein at least one processor, individually and/or collectively, is configured to execute the at least one instruction and to cause the electronic device to: identify radio resource allocation information for each of a plurality of physical channels in a first slot, based on a control plane message including radio resource allocation information for the first slot, identify each of the predicted computation amounts for each of the plurality of physical channels based on the radio resource allocation information for each of the plurality of physical channels, identify an available computation amount for each of a plurality of hardware resources supported by the electronic device, and allocate each of the plurality of physical channels to at least some of the plurality of hardware resources, based on the available computation amount for each of the plurality of hardware resources and the predicted computation amount for each of the plurality of physical channels.

According to various example embodiments, the radio resource allocation information for each of the plurality of physical channels in the first slot may include the number of resource block RBs and/or the number of symbols for each of the plurality of physical channels.

According to various example embodiments, at least one processor, individually and/or collectively, is configured to, as at least part of identifying each of the predicted computation amounts for each of the plurality of physical channels based on the radio resource allocation information for each of the plurality of physical channels, identify each of the predicted computation amounts for each of the plurality of physical channels based on performing calculation using the number of RBs and/or the number of symbols for each of the plurality of physical channels.

According to various example embodiments, at least one processor, individually and/or collectively, is configured to, as at least part of identifying each of the predicted computation amounts for each of the plurality of physical channels based on the radio resource allocation information for each of the plurality of physical channels, identify each of the predicted computation amounts for each of the plurality of physical channels using association information between the number of RBs and/or the number of symbols for each of the plurality of physical channels and the number of RBs and/or the number of symbols for each of the plurality of physical channels in a past and the computation amount.

According to various example embodiments, at least one processor, individually and/or collectively, is configured to, as at least part of identifying each of the predicted computation amounts for each of the plurality of physical channels based on the radio resource allocation information for each of the plurality of physical channels, identify each of the predicted computation amounts for each of the plurality of physical channels using association information between the number of RBs and/or the number of symbols for each of the plurality of physical channels and the number of RBs and/or the number of symbols for each of the plurality of physical channels in a past and the computation amount.

According to various example embodiments, at least one processor, individually and/or collectively, is configured to, as at least part of identifying each of the predicted computation amounts for each of the plurality of physical channels based on the radio resource allocation information for each of the plurality of physical channels, identify each of predicted computation amounts for each of the plurality of physical channels, based on the radio resource allocation information for each of the plurality of physical channels and at least one piece of additional information. The at least one piece of additional information may include at least one of the number of antennas used to transmit and/or receive the plurality of physical channels, the number of layers of the plurality of physical channels, or the number of user equipments (UEs) connected to the electronic device.

According to various example embodiments, at least one processor, individually and/or collectively, is configured to, as at least part of allocating each of the plurality of physical channels to at least some of the plurality of hardware resources, based on the available computation amount for each of the plurality of hardware resources and the predicted computation amount for each of the plurality of physical channels, allocate each of the plurality of physical channels to at least some of the plurality of hardware resources so that an available computation amount of each of the at least some of the plurality of hardware resources is equal to or larger than a sum of computation amounts of at least one allocated physical channel.

According to various example embodiments, at least one processor, individually and/or collectively, is configured to, as at least part of allocating each of the plurality of physical channels to at least some of the plurality of hardware resources, based on the available computation amount for each of the plurality of hardware resources and the predicted computation amount for each of the plurality of physical channels, identify latency for each of the plurality of physical channels based on the predicted computation amount for each of the plurality of physical channels, and allocate each of the plurality of physical channels to at least some of the plurality of hardware resources, based on the available computation amount for each of the plurality of hardware resources, the predicted computation amount for each of the plurality of physical channels, and the latency for each of the plurality of physical channels.

According to various example embodiments, at least one processor, individually and/or collectively, is configured to, as at least part of allocating each of the plurality of physical channels to at least some of the plurality of hardware resources, based on the available computation amount for each of the plurality of hardware resources, the predicted computation amount for each of the plurality of physical channels, and the latency for each of the plurality of physical channels, identify the plurality of allocation policies so that an available computation amount of each of at least some of the plurality of hardware resources is equal to or larger than a sum of computation amounts of at least one allocated physical channel, and select one of the plurality of allocation policies based on the latency for each of the plurality of physical channels of each of the plurality of allocation policies.

According to various example embodiments, at least one processor, individually and/or collectively, is configured to, as at least part of selecting one of the plurality of allocation policies based on the latency for each of the plurality of physical channels of each of the plurality of allocation policies, select the one allocation policy in which the latency for each of the plurality of physical channels is less than or equal to a latency limit for each of the plurality of physical channels.

According to various example embodiments, at least one processor, individually and/or collectively, is configured to, as at least part of selecting one of the plurality of allocation policies based on the latency for each of the plurality of physical channels of each of the plurality of allocation policies, based on there being the plurality of candidate allocation policies in which the latency for each of the plurality of physical channels is less than or equal to the latency limit for each of the plurality of physical channels, select the one allocation policy from among the plurality of candidate allocation policies.

According to various example embodiments, at least one processor, individually and/or collectively, is configured to, as at least part of selecting one of the plurality of allocation policies based on the latency for each of the plurality of physical channels of each of the plurality of allocation policies may include, based on there being the plurality of candidate allocation policies in which the latency for each of the plurality of physical channels is less than or equal to the latency limit for each of the plurality of physical channels, select an allocation policy using a minimum hardware resource from among the plurality of candidate allocation policies.

According to various example embodiments, at least one processor, individually and/or collectively, is configured to, as at least part of selecting one of the plurality of allocation policies based on the latency for each of the plurality of physical channels of each of the plurality of allocation policies, based on there being the plurality of candidate allocation policies in which the latency for each of the plurality of physical channels is less than or equal to the latency limit for each of the plurality of physical channels, select an allocation policy having a minimum latency of a designated physical channel from among the plurality of candidate allocation policies.

According to various example embodiments, a method for operating an electronic device may comprise: identifying a first radio resource allocation amount of a first physical channel and a second radio resource allocation amount of a second physical channel in a first slot based on a control plane message including radio resource allocation information for the first slot, based on a computation corresponding to the first radio resource allocation amount and the second radio resource allocation amount being performed by a first hardware resource supported by the electronic device, allocating the first physical channel and the second physical channel to the first hardware resource, and based on the computation corresponding to the first radio resource allocation amount and the second radio resource allocation amount not being performed by the first hardware resource supported by the electronic device, allocating one of the first physical channel or the second physical channel to the first hardware resource and allocating a remaining channel to the second hardware resource different from the first hardware resource.

According to various example embodiments, an electronic device may comprise: memory and at least one processor, comprising processing circuitry, operatively connected to the memory. At least one processor, individually and/or collectively, may be configured to execute at least one instruction stored in the memory and may be configured to: identify a first radio resource allocation amount of a first physical channel and a second radio resource allocation amount of a second physical channel in a first slot based on a control plane message including radio resource allocation information for the first slot, based on a computation corresponding to the first radio resource allocation amount and the second radio resource allocation amount being performed by a first hardware resource supported by the electronic device, allocate the first physical channel and the second physical channel to the first hardware resource, and based on the computation corresponding to the first radio resource allocation amount and the second radio resource allocation amount not being performed by the first hardware resource supported by the electronic device, allocate one of the first physical channel or the second physical channel to the first hardware resource and allocating a remaining channel to the second hardware resource different from the first hardware resource.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium (e.g., internal memory or external memory) that is readable by a machine (e.g., the electronic device 102). For example, a processor (e.g., the processor 120) of the machine (e.g., the electronic device 102) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for operating an electronic device, the method comprising:
identifying radio resource allocation information for each of a plurality of physical channels in a first slot, based on a control plane message including radio resource allocation information for the first slot;
identifying each of predicted computation amounts for each of the plurality of physical channels, based on the radio resource allocation information for each of the plurality of physical channels;
identifying an available computation amount for each of a plurality of hardware resources supported by the electronic device; and
allocating each of the plurality of physical channels to at least some of the plurality of hardware resources, based on the available computation amount for each of the plurality of hardware resources and the predicted computation amount for each of the plurality of physical channels.

2. The method of claim 1, wherein the radio resource allocation information for each of the plurality of physical channels in the first slot includes the number of resource block (RB) s and/or the number of symbols for each of the plurality of physical channels.

3. The method of claim 2, wherein identifying each of the predicted computation amounts for each of the plurality of physical channels based on the radio resource allocation information for each of the plurality of physical channels includes identifying each of the predicted computation amounts for each of the plurality of physical channels based on performing calculation using the number of RBs and/or the number of symbols for each of the plurality of physical channels.

4. The method of claim 2, wherein identifying each of the predicted computation amounts for each of the plurality of physical channels based on the radio resource allocation information for each of the plurality of physical channels includes identifying each of the predicted computation amounts for each of the plurality of physical channels using association information between the number of RBs and/or the number of symbols for each of the plurality of physical channels and the number of RBs and/or the number of symbols for each of the plurality of physical channels in a past and the computation amount.

5. The method of claim 1, wherein identifying each of the predicted computation amounts for each of the plurality of physical channels based on the radio resource allocation information for each of the plurality of physical channels includes identifying each of predicted computation amounts for each of the plurality of physical channels, based on the radio resource allocation information for each of the plurality of physical channels and at least one piece of additional information, and
wherein the at least one piece of additional information includes at least one of the number of antennas used to transmit and/or receive the plurality of physical channels, the number of layers of the plurality of physical channels, or the number of user equipments (UEs) connected to the electronic device.

6. The method of claim 1, wherein allocating each of the plurality of physical channels to at least some of the plurality of hardware resources, based on the available computation amount for each of the plurality of hardware resources and the predicted computation amount for each of the plurality of physical channels includes allocating each of the plurality of physical channels to at least some of the plurality of hardware resources so that an available computation amount of each of the at least some of the plurality of hardware resources is equal to or larger than a sum of computation amounts of at least one allocated physical channel.

7. The method of claim 1, wherein allocating each of the plurality of physical channels to at least some of the plurality of hardware resources, based on the available computation amount for each of the plurality of hardware resources and the predicted computation amount for each of the plurality of physical channels includes:
identifying latency for each of the plurality of physical channels based on the predicted computation amount for each of the plurality of physical channels; and
allocating each of the plurality of physical channels to at least some of the plurality of hardware resources, based on the available computation amount for each of the plurality of hardware resources, the predicted computation amount for each of the plurality of physical channels, and the latency for each of the plurality of physical channels.

8. The method of claim 7, wherein allocating each of the plurality of physical channels to at least some of the plurality of hardware resources, based on the available computation amount for each of the plurality of hardware resources, the predicted computation amount for each of the plurality of physical channels, and the latency for each of the plurality of physical channels includes:
identifying the plurality of allocation policies so that an available computation amount of each of at least some of the plurality of hardware resources is equal to or larger than a sum of computation amounts of at least one allocated physical channel; and
selecting one of the plurality of allocation policies based on the latency for each of the plurality of physical channels of each of the plurality of allocation policies.

9. The method of claim 8, wherein selecting one of the plurality of allocation policies based on the latency for each of the plurality of physical channels of each of the plurality of allocation policies includes selecting the one allocation policy in which the latency for each of the plurality of physical channels is less than or equal to a latency limit for each of the plurality of physical channels.

10. The method of claim 9, wherein selecting one of the plurality of allocation policies based on the latency for each of the plurality of physical channels of each of the plurality of allocation policies includes, based on there being the plurality of candidate allocation policies in which the latency for each of the plurality of physical channels is less than or equal to the latency limit for each of the plurality of physical channels, selecting the one allocation policy from among the plurality of candidate allocation policies.

11. The method of claim 10, wherein selecting one of the plurality of allocation policies based on the latency for each of the plurality of physical channels of each of the plurality of allocation policies includes, based on there being the plurality of candidate allocation policies in which the latency for each of the plurality of physical channels is less than or equal to the latency limit for each of the plurality of physical channels, selecting an allocation policy using a minimum hardware resource from among the plurality of candidate allocation policies.

12. The method of claim 10, wherein selecting one of the plurality of allocation policies based on the latency for each of the plurality of physical channels of each of the plurality of allocation policies includes, based on there being the plurality of candidate allocation policies in which the latency for each of the plurality of physical channels is less than or equal to the latency limit for each of the plurality of physical channels, selecting an allocation policy having a minimum latency of a designated physical channel from among the plurality of candidate allocation policies.

13. An electronic device, comprising:
memory; and
at least one processor, comprising processing circuitry, operatively connected to the memory, wherein the memory stores at least one instruction, wherein at least one processor, individually and/or collectively, is configured to execute the at least one instruction and to cause the electronic device to:
identify radio resource allocation information for each of a plurality of physical channels in a first slot, based on a control plane message including radio resource allocation information for the first slot;
identify each of the predicted computation amounts for each of the plurality of physical channels based on the radio resource allocation information for each of the plurality of physical channels,
identify an available computation amount for each of a plurality of hardware resources supported by the electronic device; and
allocate each of the plurality of physical channels to at least some of the plurality of hardware resources, based on the available computation amount for each of the plurality of hardware resources and the predicted computation amount for each of the plurality of physical channels.

14. The electronic device of claim 13, wherein the radio resource allocation information for each of the plurality of physical channels in the first slot includes the number of resource block (RBs) and/or the number of symbols for each of the plurality of physical channels, and
wherein at least one processor, individually and/or collectively, is configured to cause the electronic device to, as at least part of identifying each of the predicted computation amounts for each of the plurality of physical channels based on the radio resource allocation information for each of the plurality of physical channels, identify each of the predicted computation amounts for each of the plurality of physical channels based on performing calculation using the number of RBs and/or the number of symbols for each of the plurality of physical channels.

15. The electronic device of claim 13, wherein at least one processor, individually and/or collectively, is configured to cause the electronic device to, as at least part of allocating each of the plurality of physical channels to at least some of the plurality of hardware resources, based on the available computation amount for each of the plurality of hardware resources and the predicted computation amount for each of the plurality of physical channels, allocate each of the plurality of physical channels to at least some of the plurality of hardware resources so that an available computation amount of each of the at least some of the plurality of hardware resources is equal to or larger than a sum of computation amounts of at least one allocated physical channel.
